(19) United States
(12) Patent Application Publication
(10) Pub. No.: US 2012/0317053 A1
(43) Pub. Date: Dec. 13, 2012

(54) FIXED INCOME SECURITIES MARKET DATA DISPLAY

(75) Inventors: William J. Gartland, Fairfield, CT (US); Jim Driscoll, New York, NY (US); AJ Lindeman, New York, NY (US); Peter Cotton, New York, NY (US)

(73) Assignee: BENCHMARK SOLUTIONS HOLDINGS, INC., New York, NY (US)

(21) Appl. No.: 13/492,641

(22) Filed: Jun. 8, 2012

Related U.S. Application Data
(60) Provisional application No. 61/495,793, filed on Jun. 10, 2011.

(51) Int. Cl. G06Q 40/06; G06Q 40/04

(52) U.S. Cl. 705/36 R; 705/37

(57) ABSTRACT

A machine-implemented method includes: obtaining transaction data relating to one or more financial assets, the transaction data including the identity of the one or more financial assets, corresponding valuation data for the one or more financial assets, and corresponding volume data for the one or more financial assets; receiving, at the data processing apparatus, a request to display information relating to a first financial asset from the one or more financial assets; generating, in response to receiving the request, output data for display at a user terminal, in which the output data includes a user interface that displays at least a portion of the transaction data relating to the first financial asset and market projection information relating to the first financial asset, in which the market projection information is substantially contemporaneous with the portion of transaction data; and transmitting the output data to the user terminal.

### CROSS-REFERENCE TO RELATED APPLICATIONS

This application claims the benefit of U.S. Provisional Patent Application Ser. No. 61/495,793, filed on Jun. 10, 2011, the entire contents of which is hereby incorporated by reference.

### BACKGROUND

In the United States corporate bond market alone, there are approximately 20,000 Financial Industry Regulatory Authority (FINRA) Transaction Reporting and Compliance Engine (TRACE) eligible bonds, all of which can be traded Over-The-Counter (OTC). On any particular day, only about 25% of these bonds trade at least once, and of those, only about 3% trade three or more times. Nor is it always the same 25% that trade every day or the same 3% that trade three times or more. For example, any individual bond can trade once and then not trade again for months or more. In some cases, an event can take place which causes another bond to trade frequently for one day and then that bond may not trade again for months. Thus, in general, the US corporate bond market is fragmented and is highly illiquid for most bond issues. Markets for other types of assets and fixed income securities, such as certain types of credit default swaps, also have similar illiquidity. Furthermore, in addition to the TRACE data, traders may rely heavily on information from market makers to get a glimpse of value across the broader market. This information can include, for example, quotes provided by dealers directly to their buy-side customers over the telephone, end-of-day (EOD) quotes to market data vendors such as MarkIt, International Data Corporation (IDC), and Bloomberg, and intraday indicative quotes via thousands of emails that are parsed by other market data vendors such as MarkIt, Credit Market Analysis (CMA), and Bloomberg. The quantity, quality and timing of this information varies widely and the distribution process is significantly fragmented. As a result, traders and investors are left to make decisions based on incomplete and sparse observations of market conditions, leading to inefficiency and potential overpayment for assets.

### SUMMARY

The present disclosure relates to displaying information related to fixed income securities and derivatives. In certain implementations, the present disclosure covers methods for displaying asset transactions and/or substantially contemporaneous reference prices that relate to the asset transactions, in which the contemporaneous reference prices reflect current information about interest rates, credit, volatility, and overall market demand, among other market information before price information about a particular substantially contemporaneous trade is even known.

An innovative aspect of the subject matter described in this specification can be embodied in a system for generating financial data for display at a user terminal, in which the system includes: a market data interface configured to receive transaction data relating to one or more financial assets, the transaction data including the identity of the one or more financial assets, corresponding valuation data for the one or more financial assets, and corresponding volume data for the one or more financial assets; a user query interface configured to 1) receive requests from a user terminal to display information relating to a first financial asset from the one or more financial assets and 2) send output data to the user terminal; a processor coupled to the market data interface and the user query interface, the processor being operable to generate the output data for display by the user terminal, in which the output data, once rendered by the user terminal, includes a user interface that displays at least a portion of the transaction data relating to the first financial asset and market projection information relating to the first financial asset, in which the market projection information is substantially contemporaneous with the portion of the transaction data.

Other embodiments of this aspect include corresponding methods, computer apparatus, and computer program products encoded on computer-readable media, each operable to cause a data processing apparatus to perform the actions of the methods. A system of one or more computers can be configured to perform particular operations or actions by virtue of having software, firmware, hardware, or a combination of them installed on the system that in operation causes the system to perform the actions. One or more computer program products can be configured to perform particular operations or actions by virtue of including instructions that, when executed by data processing apparatus, cause the apparatus to perform the actions.

The foregoing and other embodiments can each optionally include one or more of the following features, alone or in combination. For example, the user interface can include a display of the transaction data relating to the first financial asset arranged in a scatter plot, in which a first-axis of the plot can correspond to valuation data and a second axis of the plot corresponds to time data. The transaction data relating to the first financial asset, once rendered by the user terminal, can include one or more transaction icons, in which each transaction icon represents a corresponding trade of the first financial asset. For each transaction icon in the display, at least one icon property selected from the group consisting of color, brightness, texture and size is representative of volume data for the corresponding trade of the first financial asset. The transaction data relating to the first financial asset further can include data relating to the identity of a party participating in each trade of the first financial asset. For each transaction icon in the display, at least one icon property selected from the group consisting of color, brightness, texture and size can indicate whether the corresponding trade of the first financial asset is a dealer-dealer trade, a buyer-dealer trade, or a seller-dealer trade. The user interface can include a display of the market projection information overlaid with the transaction data. The market projection information can include one or more projected transaction prices for the first financial asset, each transaction icon being substantially contemporaneous with a corresponding projected transaction price. The one or more projected transaction prices, once rendered by the user terminal, can be in the form of a line plot. The market projection information can include one or more projected bid-ask spread values, each bid-ask spread value being associated with a corresponding projected transaction price. The one or more projected bid-ask spread values, once rendered by the user terminal, can be in the form of a band surrounding the corresponding one or more projected transaction prices. The band can be semi-transparent. The one or more projected bid-ask spread values, once rendered by the user terminal, can be graphically indicative of a difference between a projected bid price for the first financial asset and a projected ask price for the first financial asset.

In some implementations, the processor is operable to: receive a request to display the transaction data relating to the first financial asset for a selected time period; and generate, in response to receiving the request, the output data, in which the output data can include the transaction data for the selected time period.

In some implementations, the user interface can include a display of a list of selectable financial assets. In certain implementations, the one or more financial assets can include a fixed income security or a derivative. In some implementations, the market data interface is further configured to receive underlying data associated with the valuation data of the first financial asset, in which the underlying data includes at least one metric selected from the group consisting of current risk-free rates, local credit basis, and fixed income security specific basis. The processor can be further operable to generate additional output data for display by the user terminal, in which the additional output data, once rendered by the user terminal, includes a comparison of the underlying data associated with the first financial asset on a first date to the underlying data associated with the first financial asset on a second date. The user interface can include a display of the effect of the underlying data on the valuation of the first financial asset. The user interface can include a display of a yield curve for the first financial asset based at least in part on the underlying data for the first financial asset over different maturity terms, in which the yield curve is arranged in a two-dimensional or three-dimensional plot. The user interface can include a display of the yield curve plotted against the different maturity terms. The user interface can include a display of an issuer yield curve, in which the issuer yield curve represents a yield value for each financial asset issued by the issuer.

Another innovative aspect of the subject matter described in this specification can be embodied in a machine-implemented method that includes: obtaining, using a data processing apparatus, transaction data relating to one or more financial assets, the transaction data including the identity of the one or more financial assets, corresponding valuation data for the one or more financial assets, and corresponding volume data for the one or more financial assets; receiving, at the data processing apparatus, a request to display information relating to a first financial asset from the one or more financial assets; generating, using the data processing apparatus and in response to receiving the request, output data for display at a user terminal, in which the output data, once rendered by the user terminal, includes a user interface that displays at least a portion of the transaction data relating to the first financial asset and market projection information relating to the first financial asset, in which the market projection information is substantially contemporaneous with the portion of transaction data; and transmitting the output data to the user terminal.

Other embodiments of this aspect include corresponding systems, computer apparatus, and computer program products encoded on computer-readable media, each operable to cause a data processing apparatus to perform the actions of the methods.

The foregoing and other embodiments can each optionally include one or more of the following features, alone or in combination. For example, the user interface can include a display of the transaction data relating to the first financial asset arranged in a scatter plot, in which a first-axis of the plot corresponds to valuation data and a second axis of the plot corresponds to time data. The transaction data relating to the first financial asset, once rendered by the user terminal, can include one or more transaction icons, in which each transaction icon represents a corresponding trade of the first financial asset. For each transaction icon in the display, at least one icon property selected from the group consisting of color, brightness, texture and size can be representative of volume data for the corresponding trade of the first financial asset. The transaction data relating to the first financial asset further can include data relating to the identity of a party participating in each trade of the first financial asset. For each transaction icon in the display, at least one icon property selected from the group consisting of color, brightness, texture and size can indicate whether the corresponding trade of the first financial asset is a dealer-dealer trade, a buyer-dealer trade, or a seller-dealer trade. The user interface can include a display of the market projection information overlaid with the transaction data. The market projection information can include one or more projected transaction prices for the first financial asset, each transaction icon being substantially contemporaneous with a corresponding projected transaction price. The one or more projected transaction prices, once rendered by the user terminal, can be in the form of a line plot. The market projection information can include one or more projected bid-ask spread values, each bid-ask spread value being associated with a corresponding projected transaction price. The one or more projected bid-ask spread values, once rendered by the user terminal, can be in the form of a band surrounding the corresponding one or more projected transaction prices. The band can be semi-transparent. The one or more projected bid-ask spread values, once rendered by the user terminal, can be graphically indicative of a difference between a projected bid price for the first financial asset and a projected ask price for the first financial asset.

In some implementations, the method further includes receiving, at the data processing apparatus, a request to display the transaction data relating to the first financial asset for a selected time period; and generating, in response to receiving the request, the output data, in which the output data comprises the transaction data for the selected time period.

In some implementations, the user interface includes a display of a list of selectable financial assets. The one or more financial assets can include a fixed income security or a derivative.

In some implementations, the method further includes obtaining, using the data processing apparatus, underlying data associated with the valuation data of the first financial asset, the underlying data including at least one of current risk-free rates, local credit basis, and fixed income security specific basis. The method can further include generating, using the data processing apparatus, additional output data for display by the user terminal, in which the additional output data, once rendered by the user terminal, includes a comparison of the underlying data associated with the first financial asset on a first date to the underlying data associated with the first financial asset on a second date. The user interface can include a display of the effect of the underlying data on the valuation of the first financial asset.

The user interface can include a display of a yield curve for the first financial asset based at least in part on the underlying data for the first financial asset over different maturity terms, in which the yield curve is arranged in a two-dimensional or three-dimensional plot. The user interface can include a display of the yield curve plotted against the different maturity terms. The user interface can include a display of an issuer yield curve, in which the issuer yield curve represents a yield value for each financial asset issued by the issuer.

Another innovative aspect of the subject matter described in this specification can be embodied in a machine-implemented method that includes: sending, to a first computing device, over a communication network, a request to display information relating to a first financial asset; receiving, from the first computing device, output data, in which the output data includes transaction data relating to the first financial asset and market projection information relating to the first financial asset, in which the market projection information is substantially contemporaneous with the transaction data; and rendering the output data at a user terminal to form a user interface, in which the user interface includes a display of the transaction data relating to the first financial asset and the market projection information relating to the first financial asset.

Other embodiments of this aspect include corresponding systems, computer apparatus, and computer program products encoded on computer-readable media, each operable to cause a data processing apparatus to perform the actions of the methods.

The foregoing and other embodiments can each optionally include one or more of the following features, alone or in combination. For example, the transaction data can be arranged in a scatter plot in the user interface, in which a first-axis of the plot corresponds to valuation data and a second axis of the plot corresponds to time data. The transaction data can include one or more transaction icons, in which each transaction icon represents a corresponding trade of the first financial asset. The market projection information can be overlaid with the transaction data. The market projection information can include one or more projected transaction prices for the first financial asset, each transaction icon being substantially contemporaneous with a corresponding projected transaction price. The market projection information can include one or more projected bid-ask spread values, each bid-ask spread value being associated with a corresponding projected transaction price.

Another innovative aspect of the subject matter described in this specification can be embodied in a system for generating financial data for display at a user terminal, in which the system includes a market data interface configured to receive financial data relating to multiple financial assets; a user query interface configured to 1) receive requests from a user terminal to display market factors relating to a subset of the multiple financial assets and 2) send output data to the user terminal; a processor coupled to the market data interface and the user query interface, the processor being operable to generate, for display by the user terminal, the output data based on the financial data received at the market data interface, in which the output data, once rendered by the user terminal, includes a user interface that displays a plot of a yield curve over a range of maturity terms.

Other embodiments of this aspect include corresponding systems, computer apparatus, and computer program products encoded on computer-readable media, each operable to cause a data processing apparatus to perform the actions of the methods.

The foregoing and other embodiments can each optionally include one or more of the following features, alone or in combination. For example, the market factors can include interest rates associated with the multiple financial assets and local credit risk associated with the multiple financial assets. The output data, once rendered by the user terminal, can include a user interface that displays one or more of a plot of a risk-free rate curve over the range of maturity terms, a plot of a credit basis curve over the range of maturity terms, and a plot of a bond basis curve over the range of maturity terms. The yield curve can be associated with a portfolio of financial assets issued by a single entity. The yield curve can be associated with a portfolio of financial assets issued by multiple different entities.

Another innovative aspect of the subject matter described in this specification can be embodied in a machine-implemented method that includes: obtaining, using a data processing apparatus, financial data relating to multiple financial assets; receiving, at the data processing apparatus, a request to display factors relating to a subset of the multiple financial assets; generating, using the data processing apparatus and in response to receiving the request, output data for display at a user terminal, in which the output data, once rendered by the user terminal, includes a user interface that displays a plot of a yield curve over a range of maturity terms; and transmitting the output data to the user terminal.

Other embodiments of this aspect include corresponding systems, computer apparatus, and computer program products encoded on computer-readable media, each operable to cause a data processing apparatus to perform the actions of the methods.

The foregoing and other embodiments can each optionally include one or more of the following features, alone or in combination. For example, the market factors can include interest rates associated with the multiple financial assets and local credit risk associated with the multiple financial assets. The output data, once rendered by the user terminal, can include a user interface that displays one or more of a plot of a risk-free rate curve over the range of maturity terms, a plot of a credit basis curve over the range of maturity terms, and a plot of a bond basis curve over the range of maturity terms. The yield curve can be associated with a portfolio of financial assets issued by a single entity. The yield curve can be associated with a portfolio of financial assets issued by multiple different entities.

Another innovative aspect of the subject matter described in this specification can be embodied in a machine-implemented method that includes: sending, to a first computing device, over a communication network, a request to display factors relating to multiple financial assets; receiving, from the first computing device, output data; and rendering the output data at a user terminal to form a user interface, in which the user interface displays a plot of a yield curve over a range of maturity terms, the yield curve being associated with a portfolio of financial assets issued by multiple different entities or a portfolio of financial assets issued by a single entity.

Other embodiments of this aspect include corresponding systems, computer apparatus, and computer program products encoded on computer-readable media, each operable to cause a data processing apparatus to perform the actions of the methods.

The foregoing and other embodiments can each optionally include one or more of the following features, alone or in combination. For example, the user interface can display one or more of a plot of a risk-free rate curve over the range of maturity terms, a plot of a credit basis curve over the range of maturity terms, and a plot of a bond basis curve over the range of maturity terms.

As used herein, “fixed income securities” includes, but is not limited to, fixed income derivative instruments such as interest rate or credit default swaps.

All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments are set forth in the accompanying drawings and the description below. Other features, aspects, and advantages will be apparent from the description, the drawings, and the claims.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIGS. 1-3 are examples of screen shots displaying asset transactions and reference prices.

FIG. 4 is an example of a screen shot displaying a user interface that contains information related to various fixed income securities and derivative reporting.

FIG. 5 is an example screen shot of a “Price Attribution” user interface display.

FIG. 6 is a detailed view of the Price/Yield Breakdown Block 502 of the user interface of FIG. 5.

FIG. 7 shows a detailed view of the Change Breakdown Block 503 of the user interface of FIG. 5.

FIG. 8A shows a detailed view of the Yield Curve Block 504 of the user interface of FIG. 5.

FIG. 8B is an example screen shot of a user interface display.

FIG. 9 is a schematic representation of an exemplary system for displaying metrics according to the present disclosure.

### DETAILED DESCRIPTION

Various implementations of a fixed income securities market data display method are described herein. Implementations include corresponding systems, apparatuses, and computer programs, configured to implement the method, encoded on computer storage devices. The details of one or more implementations are set forth herein.

The problem of providing a coherent visual presentation of asset specific regulatory reporting (along with influence on market price) can be solved by plotting asset specific regulatory reporting related to a particular security within a single plot incorporating multiple metrics, including, but not limited to: (1) price; (2) time; (3) size of trade; (4) side of trade; and/or (5) participants in a trade. Furthermore, the influence on the marketplace can be seen by plotting one or more of the above metrics on the same plot as a contemporaneous projection of the market price. Moreover, received quotes can be compared to reported trades.

In general, regulatory reporting information is available regarding publicly traded securities. This reporting information includes, for example, market data about trades in financial products (e.g., securities such as fixed income securities, derivatives, and credit default swaps). For example, the market data can include transaction data about over the counter secondary market transactions in eligible fixed income securities (e.g., corporate bonds) reported by members of the FINRA under the TRACE program. Other transaction data can include, for example, transaction data obtained from centralized recordkeeping facilities, such as Swap Data Repositories (SDR) or the municipal securities rulemaking board (MSRB) Real-time Transaction Reporting System (RTRS). Such transaction data can include, for example, the price of the security associated with the transaction, yield associated with one or more transactions of a security, a transaction volume associated with one or more securities, a size of each transaction, identification of the issuer of the security, and/or transaction dates/times, among other information. For the purposes of this disclosure, transaction size is understood to mean the number of shares of a particular security purchased or sold in a single transaction, whereas transaction volume is understood to mean the total number of shares of a particular security purchased or sold over a specified set of transactions.

It is difficult to synthesize enough of the transaction information to gain an accurate picture of the market for any particular security. It is also difficult to place the information in chart form without omitting important data or overloading the user of the data with information. In the case of rarely traded securities, the scarcity of data makes it important to present the available data in as complete and intuitive a way as possible. At the same time, frequently traded securities should be presented in a way that does not overwhelm the user.

The various implementations covered by the present disclosure for displaying specific metrics within a single plot present a large amount of information in a way that is intuitive to the user, allowing the user to draw meaningful conclusions regarding market conditions, past trades and future trades, among other information. This can be done, for example, by presenting the metrics related to the traded securities within the plot through modifications of the color, brightness, size, texture and/or location of any plotted input. The data can be overlaid with substantially contemporaneous projections of transaction valuations (e.g., price, yield, or spread) for the corresponding security. Other data can be incorporated by modifying other features of the plotted input.

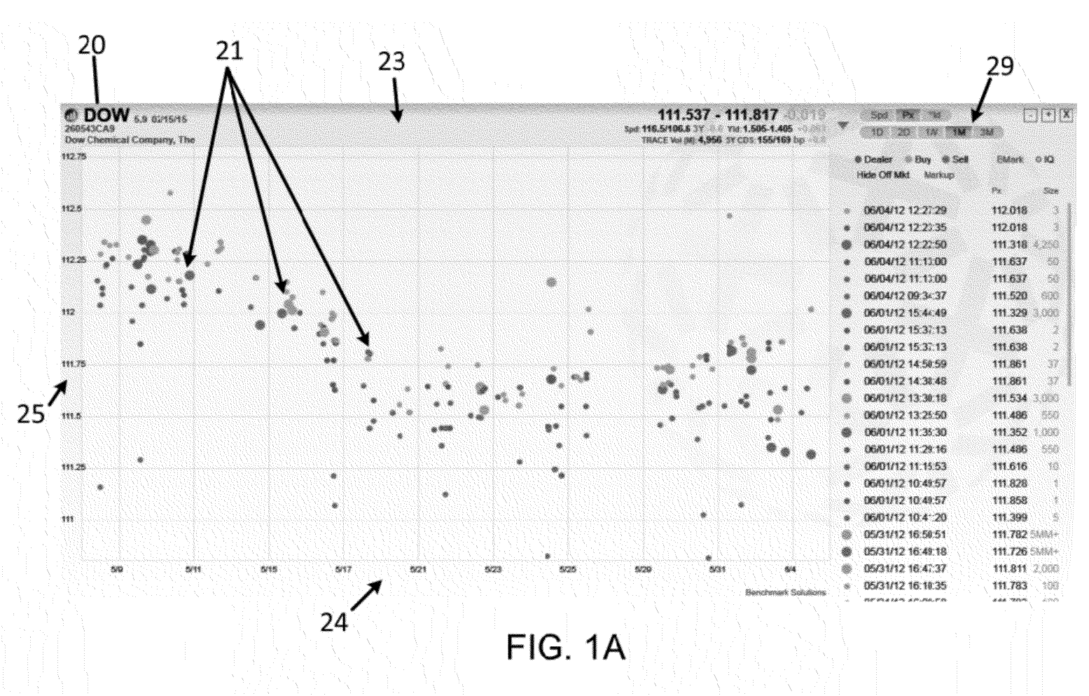

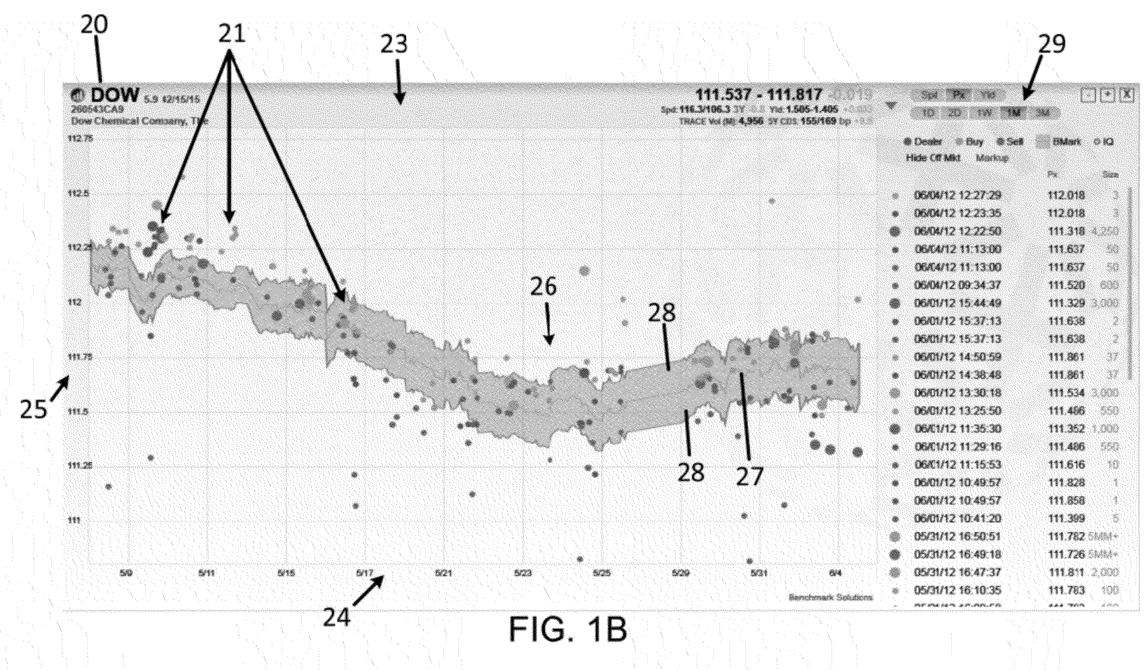

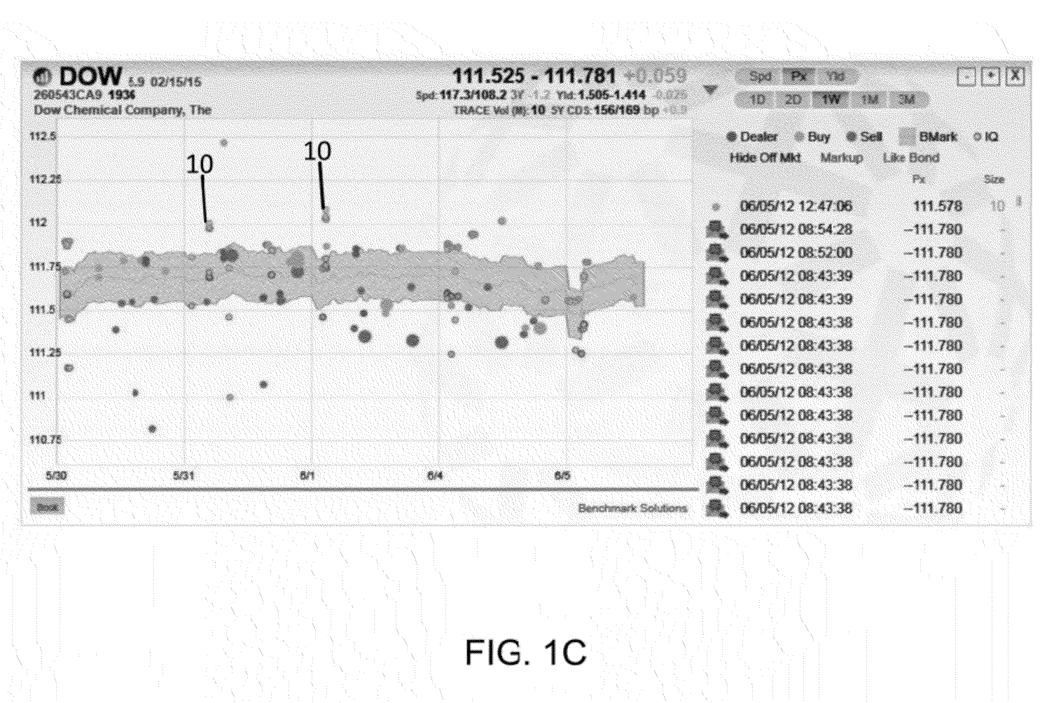

FIGS. 1-4 illustrate several implementations of a user interface for displaying transaction information related to financial products, such as fixed income securities and derivative reporting. When the process of “displaying” or “presenting” is described in this disclosure, it is understood to include the concept of causing to be displayed or presented (e.g., transmitting data that is then rendered for display or presentation at a client terminal).

FIGS. 1A, 2A, and 3A are examples of screen shots displaying asset transactions for a specific security. FIGS. 1B, 2B and 3B are examples of screen shots displaying the asset transactions of FIGS. 1A, 2A and 3A, respectively, overlaid with a substantially contemporaneous projection of transaction valuations (e.g., price, yield, or spread) for the underlying security. FIG. 4 is an example of a screen shot displaying a user interface that contains information related to various fixed income securities and derivative reporting, as well as plots of asset transactions for a specific security. In general, user interfaces such as the screen shots shown in FIGS. 1-4 are viewed by a trader engaging in the transfer of financial assets either for himself or a client. Thus, the data processing apparatus can be configured to modify the user interface in order to present data specifically relevant to an authorized trader, such as transaction quotes the trader has received or placed.

For the purposes of this disclosure, “substantially contemporaneous” means contemporaneous to the extent feasible within the processing limitations of the system, the time required to calculate the projections, the rate at which transaction data, on which projected calculations are based, is obtained by the system, and/or the ability of the system to render the projections to a display. When a series of projected transaction valuations are generated, a trade is considered to be substantially contemporaneous with the projected transaction closest in time, assuming the difference in time between the actual trade and the projected transaction is within a time period between consecutive projected transactions. In an example scenario, a system may be operable to output to a display projected transaction prices for a particular security at a minimum of every 15 seconds due to the foregoing system and communication limitations. If, for a projected transaction occurring at time t, a trade of the particular security occurs within a time t±7.5 seconds, the projected transaction is said to be substantially contemporaneous with the actual trade. Alternatively, it can be said that the trade is substantially contemporaneous with the projected transaction.

As shown in FIG. 1A, transaction data 23 (e.g., TRACE data) for a specific bond 20 are displayed as a scatter plot. The X-axis represents time and/or date 24, and the Y-axis represents transaction valuation 25 (e.g., price, spread, or yield), such that the transactions are plotted temporally. Each colored dot (“icon”) within the plot represents a single trade/transaction 21 of the particular security of interest. Though the icons are shown as circular dots in the example of FIG. 1A, the icons can take various shapes including, for example, any polygon, curvilinear, or any other icon shape suitable for rendering to a display. In the present example, the particular security for which transaction data is being displayed is a corporate bond for the Dow Chemical Company. The transactions 21 displayed in the interface can include, for example, seller-dealer transactions, dealer-dealer transactions, and/or buyer-dealer transactions. A dealer is an entity (e.g., an individual or group of individuals) that facilitates trades between entities selling securities (sellers) and entities purchasing securities (buyers). The time 24 along the X axis can be adjusted by selecting a different time frame 29. For example, the length of time displayed can be selected to be 1 hour, 6 hours, 12, hours, 1 day, 2 days, 1 week, 2 weeks, 1 month, 3 months, 6 months, 1 year, 2 years, or some other user selected time frame. In some implementations, the user interface displays several radio buttons representing different time frames that can be selected. In some implementations, the user interface can include a text entry box that allows a user to enter a specific time frame to view.

The system can modify various visible features of each transaction icon 21 to impart information to a user. In some implementations, the color of the icon 21 can represent the initiating sides of a transaction, and/or the type of participants. For example, icons representative of transactions between a customer/seller and a dealer can be displayed in a first color (e.g., red), icons representative of transactions between dealers can be displayed in a second color (e.g., magenta), and icons representative of transactions between dealers and buyers can be displayed in a third color (e.g., blue).

In some implementations, the brightness of the colors associated with each transaction icon 21 can represent a different metric. For example, the brightness can be representative of a size of the trade associated with the icon 21, where trade size corresponds to how many shares of the selected bond are traded in a single transaction. Thus, in one example, trades in which a large number of shares of a particular security were sold/purchased will be displayed brighter than trades in which a smaller number of shares of the security were sold/purchased. Thus, in another example, larger trades will be displayed as larger circles whereas smaller trades will be displayed as smaller circles. In some implementations, the size of the transaction can be represented based on a combination of changes in icon size, color, texture or brightness. Whatever the variation in the icon feature, the variation can be proportional to the change in the trade size. In certain implementations, additional data underlying a transaction can be displayed in response to a user-triggered event. A user-triggered event can include, for example, a user clicking on a transaction icon or a user performing a mouse-over of an icon. The underlying data displayed on the user interface can include, for example, number of bids or offers on the particular security, the exact time of the trade, the exact trade amount, and/or other details related to the security or the transaction. In some implementations, a user can click on an icon 21 to display bids and offers received in the form of an underlying email. In some implementations, a user can click on a transaction icon 21 to view information related to the underlying trace feed, such as the exact date or time of a transaction, the price, yield, or volume associated with the security for a specified number of transactions, as well as other fields. In some implementations, access to the foregoing features can be restricted to certain users. For example, certain users may not have authorization rights to access certain features unless the user logs into the system using login credentials recognized by the system. The user in such cases may be restricted to viewing, for example, the transaction icons 21 but not the underlying data associated with the trades.

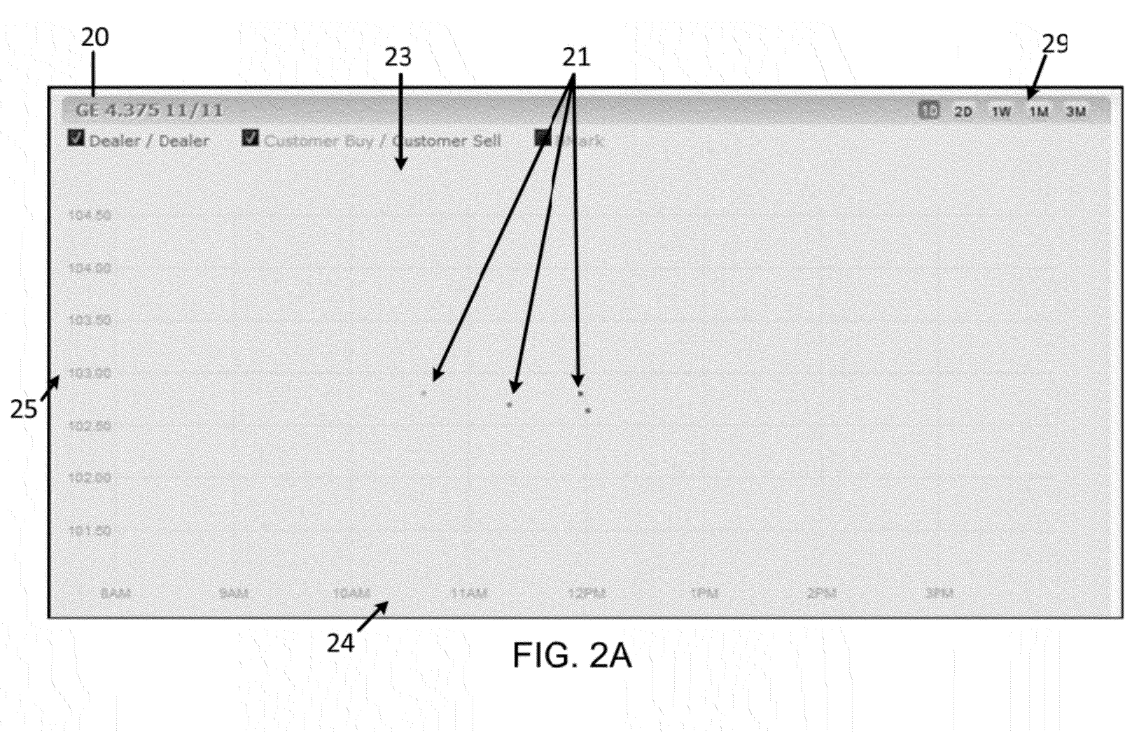

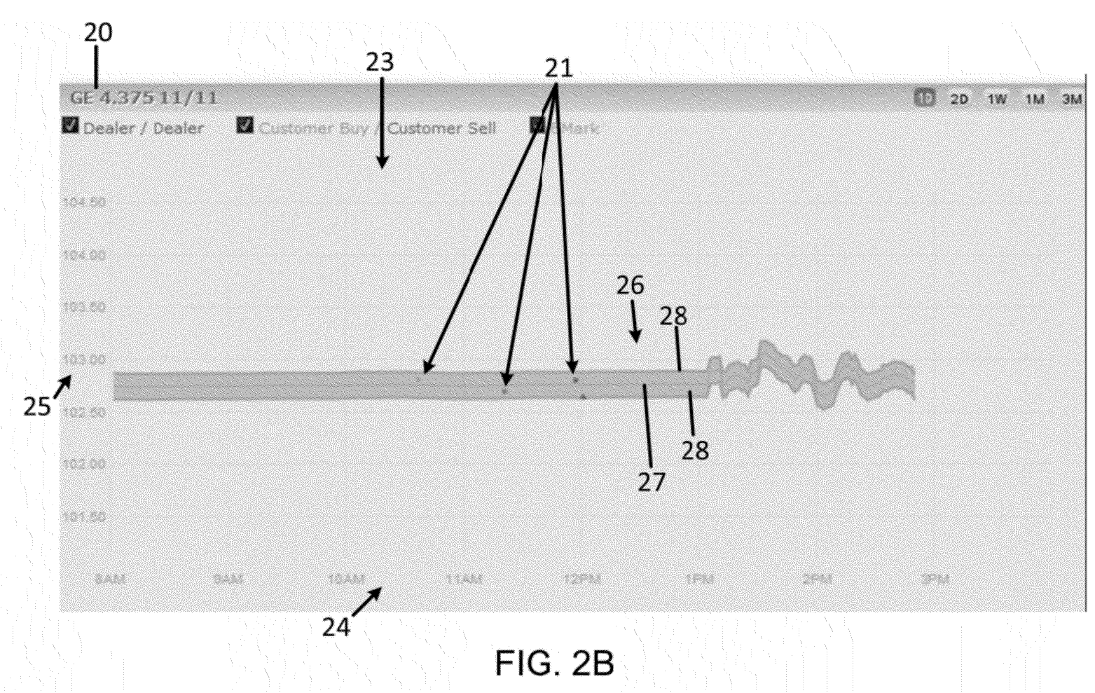

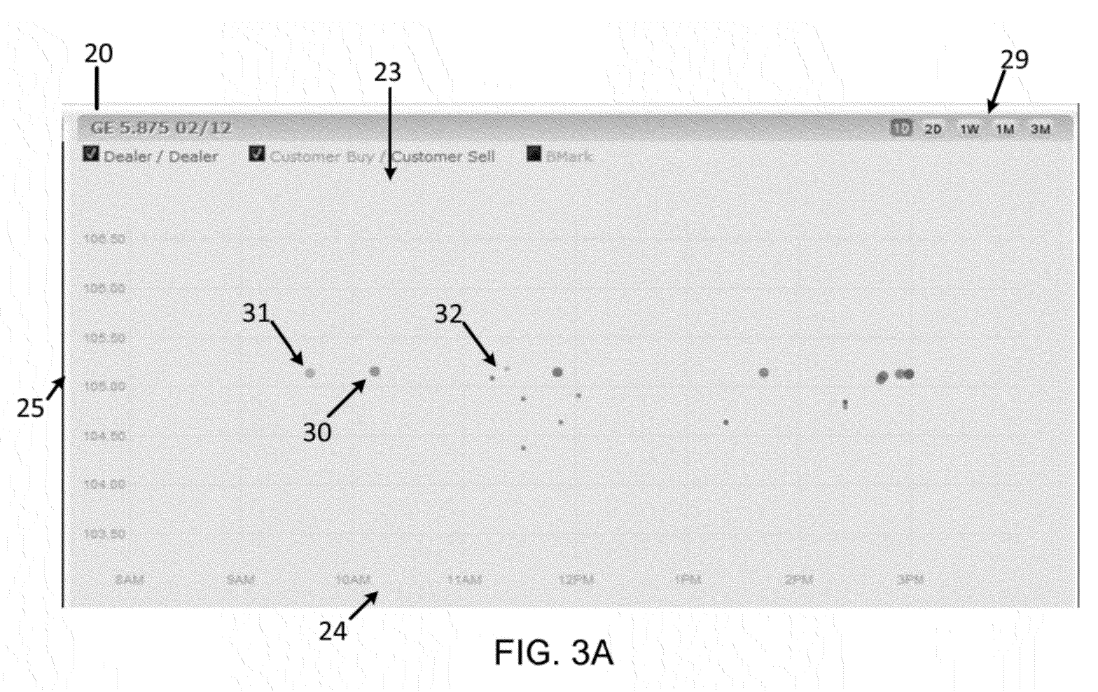

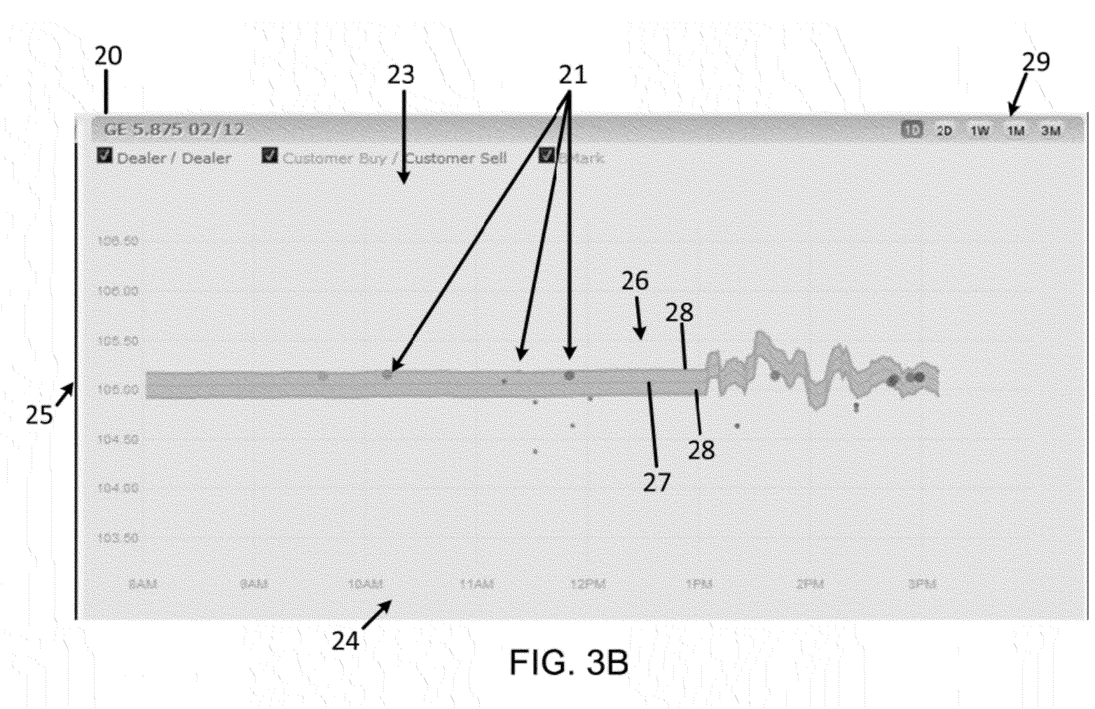

FIGS. 2A and 3A are also scatter plots of transaction data 23 for a selected bond 20. In the examples shown in FIGS. 1-3, transactions are represented by either small filled circles or large filled circles. A large filled circle represents a medium transaction (e.g., $1 million or more) for the particular security at the corresponding transaction valuation. A small filled circle represents a small transaction (e.g., less than $1 million) for the particular security at the corresponding price. A large filled circle with a brighter color represents a large transaction ($5 million or more). In the example of FIG. 3A, sample trade 30 corresponds to a customer buy at 10:08 am for about $105.1. The sample trade 30 followed a larger customer buy 31 at 9:35 am and preceded a series of smaller trades 32 after 11 am. The difference in trade size can be represented by a difference in shading between the icons.

As explained above, the user interface also can be configured to display transaction quotes that a trader has received or placed. In some implementations, the user interface can be configured to display an indication that quotes are available for a particular transaction. For example, FIG. 1C is an example screen shot of a user interface in which transactions 10 are surrounded by a halo (i.e., the outer boundary of the circle icon is bold and in a different color than the icon core). The halo feature on the icon indicates that a transaction quote is available for that particular trade. Quotes may also be available for proposed transactions in which no actual trade has occurred. In such cases, the quote is depicted in the user interface as the halo alone (i.e., there is no transaction icon to fill the core portion of the halo).

In some implementations, the data processing apparatus can also be configured to display a market valuation projection within the user interface. For example, each of FIGS. 1B, 1C, 2B, and 3B show projected market valuation information 26 that can be viewed alongside the plotted transactions 21. In particular, FIGS. 1B, 2B, and 3B show projected transaction pricing overlaid with transaction data from FIGS. 1A, 2A, and 3A, respectively. The projected market valuation information 26 includes a center-line 27 bounded above and below by a band 28. The center-line 27 represents a projected price of the next transaction (e.g., a dealer-to-dealer trade to be reported to TRACE) for a particular point in time. Each projected price 27 is calculated before the actual transaction price for the same point in time is received by the data processing apparatus. Thus, the pricing information for each transaction 21 is known after calculation of the projected price 27 for the point in time at which the transaction occurs. The projected prices 27 may reflect the current information available about interest rates, credit, volatility and overall market demand. In general, projected price line 27 adjusts continuously (e.g., every second, every five seconds, every ten seconds, every fifteen seconds, etc.) based on a wide range of past and current market observations including, for example, newly received transaction pricing information for a particular security, changes in spreads associated with the underlying security being displayed, changes in pricing and spread information for securities issued and traded by the same entity that issued the security being displayed, and the parties involved in previously conducted trades (e.g., whether a transaction is a dealer-dealer trade, a seller-dealer trade, or a buyer-dealer trade). The projected price 27 may adjust in response to other information as well. When projected market information is calculated for the same time period as the transaction data, each transaction is understood to have a corresponding substantially contemporaneous projected transaction.

For each security, the projected price 27 can be updated on a continual basis. For example, the projected price 27 can be updated and output to a display every five seconds, every ten seconds, every fifteen seconds, every minute, or every five minutes. Other reporting periods are possible as well. The band 28 surrounding the projected price line 27 corresponds to a projected bid-ask spread of the projected price. The projected bid-ask spread 28 is calculated and updated continuously with the projected price line 27. As can be seen from FIGS. 1B, 2B, and 3B, the actual trades generally track the projected market information 26. Trades reported outside the bid-ask spread 28 can influence the magenta line, tending to move future projected prices 27 in the direction of the trade price.

Thus, the system can provide and display credible and reliable price predictions for a variety of securities. Additionally, the daily and historical charts provide a user with accurate indications of short and long term performance. For example, a buy-side investor can look to the charts to confidently evaluate intraday pricing patterns for bonds that rarely receive sell-side dealer quotes. Moreover, the display of both the projected price and the actual transactions allow a user to conduct a more robust pre-trade portfolio analysis. For example, the continuous stream of projected prices 27 can provide a portfolio manager a basis to gauge their bargaining position in specific trades. If the projected price is, say $99.00 and a buy-side investor has a received a bid of $99.50, the buy-side investor can confidently negotiate for a lower price, knowing the expected level of the next transaction is $0.50 lower. Additionally, after a trade is executed, the data can be used to perform a comprehensive transaction cost analysis to determine the quality of the trade. For example, a trader can evaluate whether there were better prices available before or after the time of execution and whether the trade had a measurable impact on the market price of the security of interest.

FIG. 4 is an example of a screen shot displaying a user interface that contains information related to various fixed income securities and derivative reporting, as well as plots of transactions for a specific security. The user interface of FIG. 4 includes a security list block 40 that lists multiple securities for a selected financial asset category. The security list block 40 can include an interactive icon 41, such as a drop-down box, that allows a user to select the category of the financial asset to be displayed. The security list block 40 also can include additional information about each of the financial assets listed. The additional information can include, for example, a projected price 42 for each corresponding security listed in block 40, the actual price 43 of the last transaction involving the corresponding security listed in block 40, the time 44 at which the last transaction occurred, the size of the last transaction 45, and/or a transaction volume 46, in which the volume corresponds to the total number of shares of a particular security purchased or sold over a specified set of transactions. Other information can be included in block 40 as well.

The projected price 42 corresponds to an estimated price of a transaction involving the corresponding security listed in the same row of block 40. Similarly, the projected price 42 is for the time 44 listed in the same row as the security. As discussed above with respect to FIGS. 1-3, the projected price 42 is calculated before the actual transaction price 43 is known. Other statistics also can be selected from the interactive icon 41 for this portion of the display, such as TRACE data, yield, spread, market data, or details of the last trade. The user interface of FIG. 4 also includes a transaction data block 50, in which transaction data may be plotted for a selected security. For example, the transaction data block 50 can include a plot similar to that shown in FIGS. 1-3, in which transaction data and projection data are overlaid with one another in a temporal plot. The user interface also can include an optional third block 60, in which various other data can be displayed. For example, as shown in FIG. 4, the third block 60 includes line plots of the price of a selected credit default swap versus time and the spread of the security versus time. The user interface also can include various other features, such as a search bar for finding securities 70.

In addition to the display of transaction data described in this disclosure, another issue is the display of the market factors that underlie pricing data and the changes in those data. Numerous factors (some of which are not intuitive) influence pricing data and a system for displaying and interrogating such data would be advantageous. The problem of providing a coherent and easily parsed visual representation of market factors contributing to both the pricing and the change in pricing of a specific asset can be addressed by:

1. Choosing market specific factors used to calculate prices for a specific financial instrument,

2. Displaying the market specific factors, as well as changes in the market specific factors over a time frame,

3. Displaying graphically the changes in market specific factors for a specific financial instrument being analyzed,

4. Displaying the market specific factors for multiple financial instruments visually on a single plot.

Several market models could give a user current pricing for a security, and any viable pricing algorithm is based on some set of factors used to determine the price of that issue. However, those factors are not necessarily intuitive to users, nor are they easy to visualize. Even if users could fully understand the factors used to generate a final price, it would be difficult to understand the relationship of that any one factor to the many others used in the calculations.

Additionally, even if a user could access those underlying factors, it would be difficult to contextualize the factors in terms of their general influence on the overall price movement of the issue, as well as the relationship of the factors to each other. Furthermore, it would be difficult to fully understand and visualize how those same factors are integrated into calculations for other bonds from the same issuer, as well as the market sector and the market as a whole. Understanding the factors and their contribution to the price movement of a selected bond can give users valuable insight into why prices move as they do across issuers, market sectors and the more global marketplace.

This set of problems can be addressed by choosing an appropriate set of factors, calculating the factors and changes in the factors over a known time period, and displaying (or causing to be displayed, e.g., rendered on a client terminal) the change in the price or yield in terms of the relevant factors alongside a display of the yield curve parsed in terms of the relevant factors.

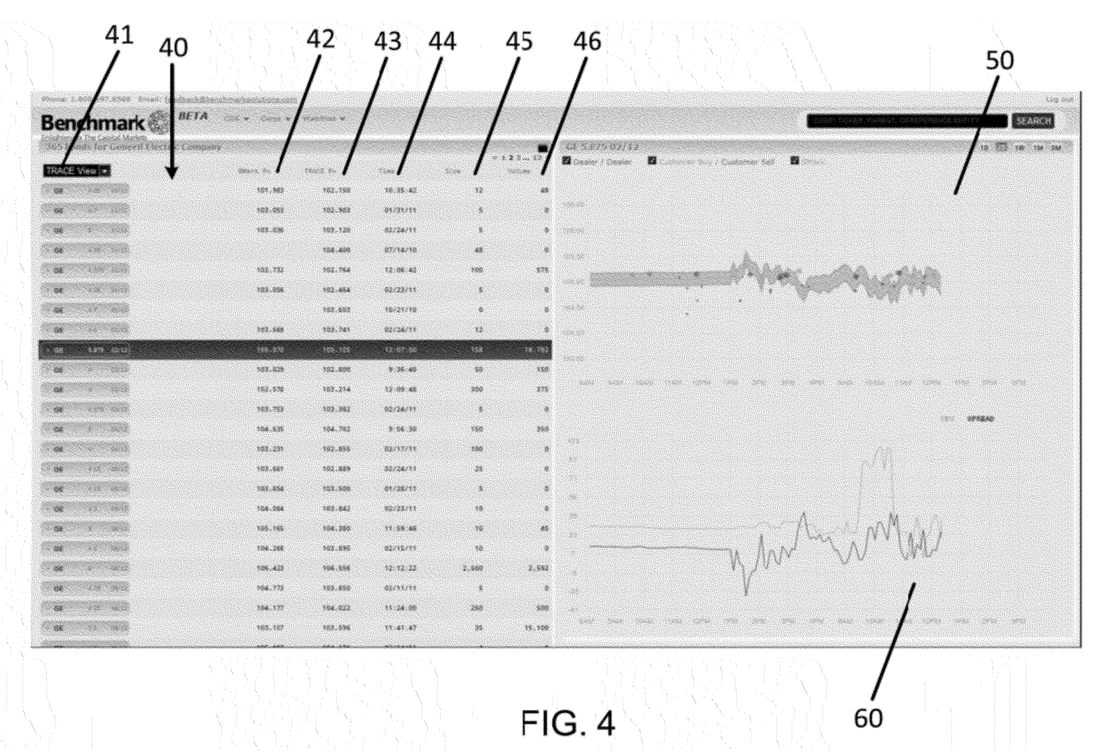

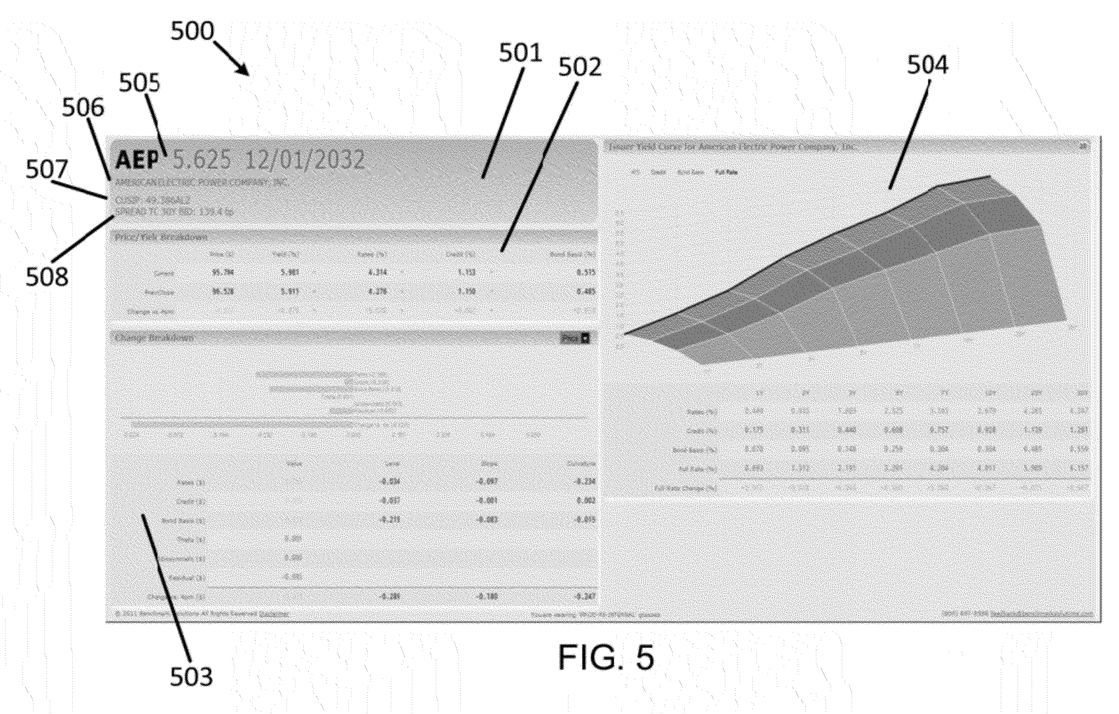

FIG. 5 is an example screen shot of a “Price Attribution” display 500 as presented to a user when that user requests attribution data related to a specific security. The screen, as currently constituted, is broken down into four blocks—a Security Description Block 501, a Price/Yield Breakdown Block 502, a Change Breakdown Block 503, and a Yield Curve Block 504. These blocks will be discussed in turn.

Within Security Description Block 501, the security can be defined in several ways. For example, the user may be shown information 505 that includes the standard ticker symbol for the issuer, along with the coupon rate and the maturity date. The basic description then can be followed by the issuer name 506 and the security identifier 507 (stating the bond in terms of its standard CUSIP identifier, defined by the Committee on Uniform Security Identification Procedures). The user interface also can show the current yield spread to the benchmark US Treasury note with the closest maturity 508. In the example of FIG. 5, the bond displayed in the Security Description Block 501 has the ticker symbol “AEP,” has a coupon rate of 5.625%, and matures in December 2032. The issuer name 506 in this example is “American Electric Power, Inc.” The standard industry convention is to quote this bond versus the most recently issued 30-year Treasury, giving a spread of 139.4 basis points.

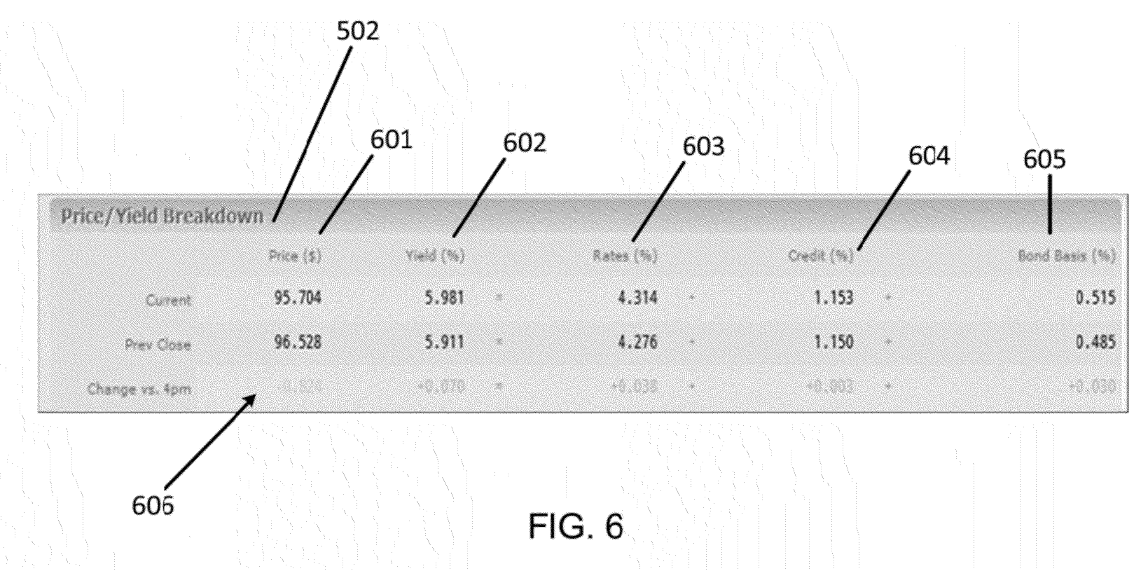

FIG. 6 shows a detailed view of the Price/Yield Breakdown Block 502 of the user interface 500 of FIG. 5. Within the Price/Yield Breakdown Block 502, the price or yield of the security can be decomposed into a set of principal metrics determined to provide valuable insight across market sectors. In the illustrated implementation, the appropriate metrics for the listed security include the current “risk-free” rates 603 of the security, the local credit basis 604, and the bond specific basis 605. The breakdown then can be used to compare the current value of each of those metrics to the same metrics at some previous time. The table shown provides the current value of each metric as compared to a reference time (in this implementation, the previous day's close) and provides the user with metric specific changes. The difference between metrics for the different times can be displayed in a separate region 606 of the Price/Yield Breakdown Block 502. Thus, the user can view the independent changes in the marketplace as applied to the independent metrics selected.

The specific metrics used in the implementation illustrated in FIG. 6 are:

1 “Risk-free” rates 603—these are interest rates extracted from the interest rate swap market,

2 Credit basis 604—this is local credit risk for the issuer as measured by credit default swaps—in this case, the current value is 115.3 basis points, or 1.153%, and

3 Bond specific basis 605—this is the issue-specific pricing behavior calculated across a range of maturity terms based on factors including, for example, issue size (e.g., number of shares of security at time of issuance), supply, demand, etc.

The values calculated by the system can then be summed up and displayed as the total yield 602 for the security. This result can then be reflected in the price 601 for the selected security.

In an alternative implementation, the price and yield for the security can be reversed, so that the breakdown is shown in terms of price, with a final conversion to yield shown in either percentage or basis points.

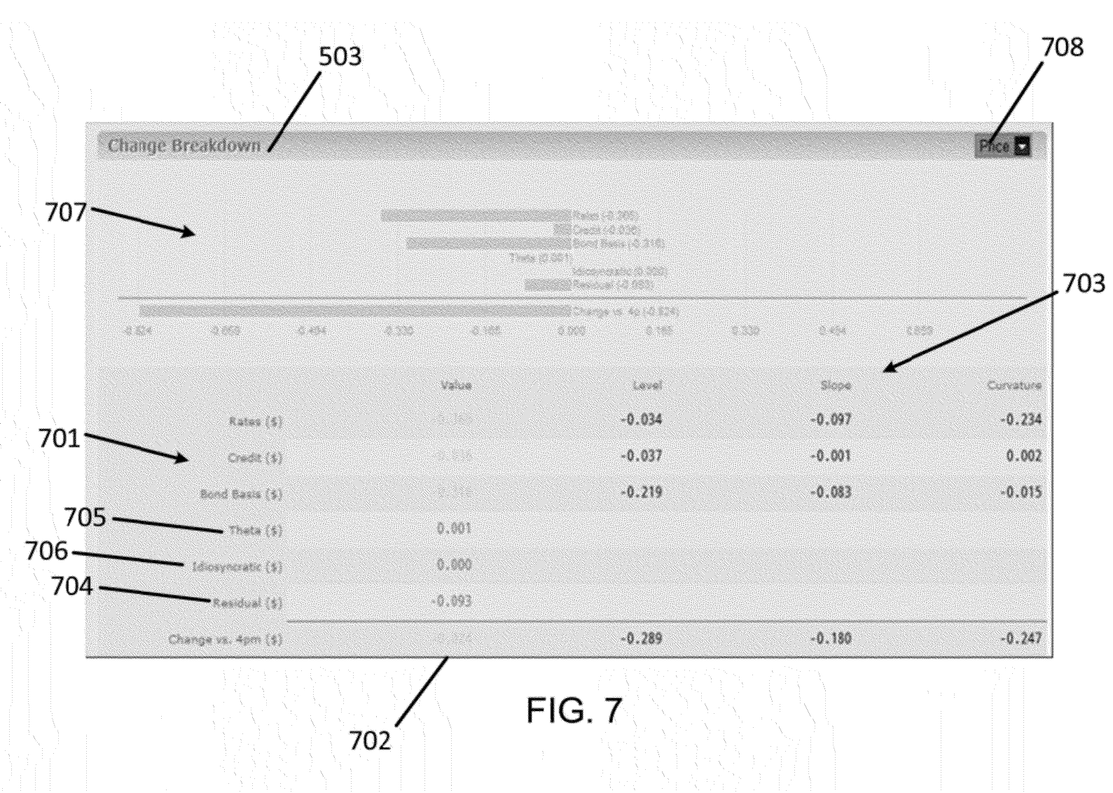

FIG. 7 shows a detailed view of the Change Breakdown Block 503 of the user interface 500 of FIG. 5. Within the Change Breakdown Block 503, changes in underlying metrics 701 (e.g., risk-free rates, credit basis, and bond specific basis) are shown as components of the overall change in price 702 for the selected security. The propagation of market factors through a pricing model generates curves for each of the underlying metrics 701, each of which can move through changes measurable by first order derivatives. The pricing model then can be used to calculate first order derivative effects attributable to each of the underlying metrics 701 of the pricing model. The first order derivative metrics 703 include, for example, changes attributable to the change in level, slope and curvature of each of the curves for the underlying metrics at the time the curves are being analyzed relative to a reference time.

The sum of the first order derivative metrics 703 (e.g., the sum of the level, slope, and curvature) is generally equal to the overall value of the corresponding underlying metric 701 (e.g., rates, credit, or bond basis). Additionally, the changes in each of the first order derivative metrics 703 (e.g., level, slope, or curvature) can be summed across the underlying metrics 701 (e.g., rates, credit, and bond basis), and presented to the user as the overall change 702 attributable to each of those first order derivative metrics. These metrics, along with their relationships to each other, can be used to coordinate advanced trading strategies. For example, the metrics can be used to coordinate strategies such as outright, steepener and butterfly strategies, among others.

Additionally, other metrics may contribute to a change in the value of the security. Instead of displaying each of these metrics individually, these second order effects can be grouped together and displayed in the Change Breakdown Block 503 of the user interface 500. For example, the Change Breakdown Block 503 can include a second order derivative effects parameter (“residual”) 704. The second order derivatives effect parameter 704 corresponds to a value equal to the sum of the residuals of parameters being modeled and the overall curve second order derivatives taken at the points measured on the three slopes corresponding to the underlying metrics 701. The Change Breakdown Block 503 also can display changes attributable to a time decay 705 (“theta”), in the security itself. That is, the time decay 705 represents a change in the value of the selected security attributable only to time, assuming all other metrics are held constant. The Change Breakdown Block 503 also can display changes in idiosyncratic security specific effects 706 that would lead to a valuation different than that implied by the sum of the other metrics.

The sum of the change in underlying metrics 701, time decay 705, security specific effects 706 and the second order derivative effects 704 combine to approximate the overall change in price 702 for the security relative to a price of the security at a reference time. While some factors can prevent a direct correlation between the sum of the presented factors and the overall change in price shown to the user, the vast majority of the price change is attributed in this manner.

Furthermore, Change Breakdown Block 503 also can display a graphic representation 707 of the changes in the metrics allowing the user to easily understand which aspects of the market are generating the current price movement, and at what scale those contributions are happening. For example, the graphical representation can include any applicable plot or chart of the metrics presented in Change Breakdown Block 503, such as a bar graph, a line graph, pie chart, etc.

In some implementations, the Change Breakdown Block 503 can include a unit selection menu 708 that allows a user to select whether to have data presented in terms of price or yield. Switching the underlying unit will reverse the plot and change the numbers, but the overall presentation will remain consistent. In the implementation shown in FIG. 7, the data are presented in terms of price.

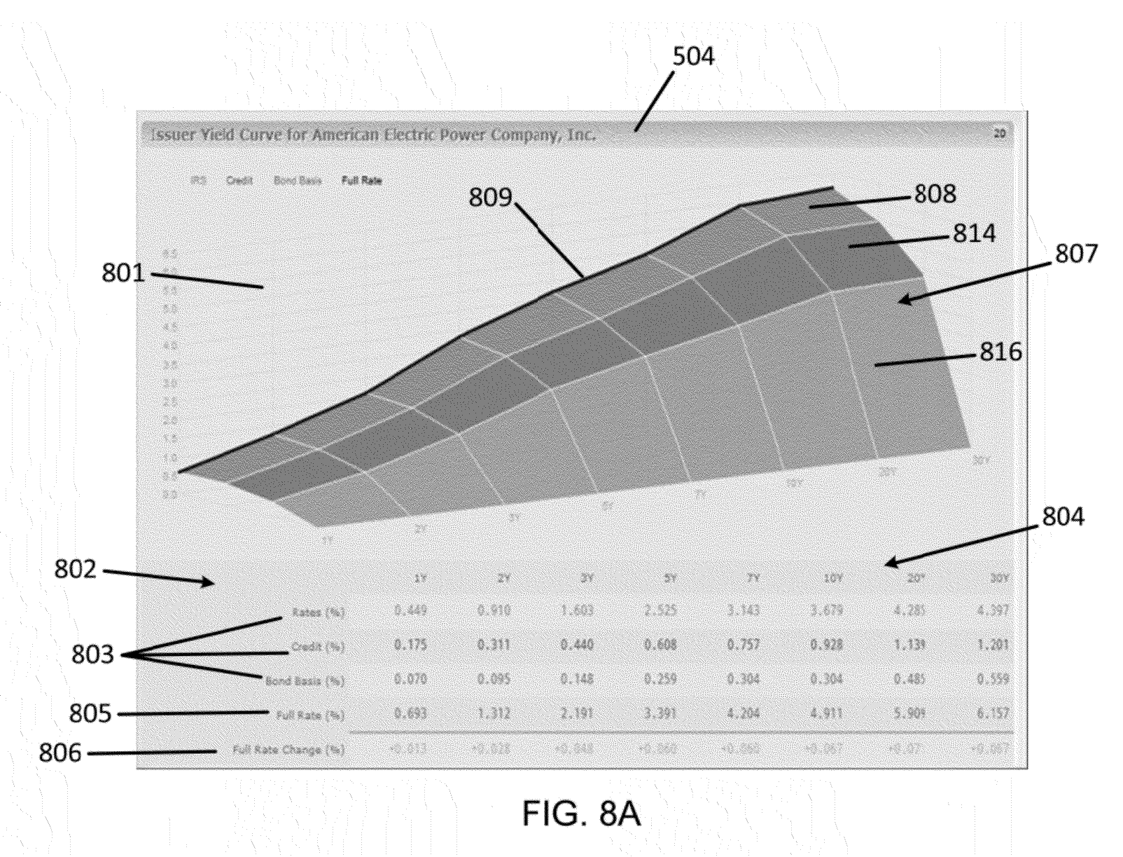

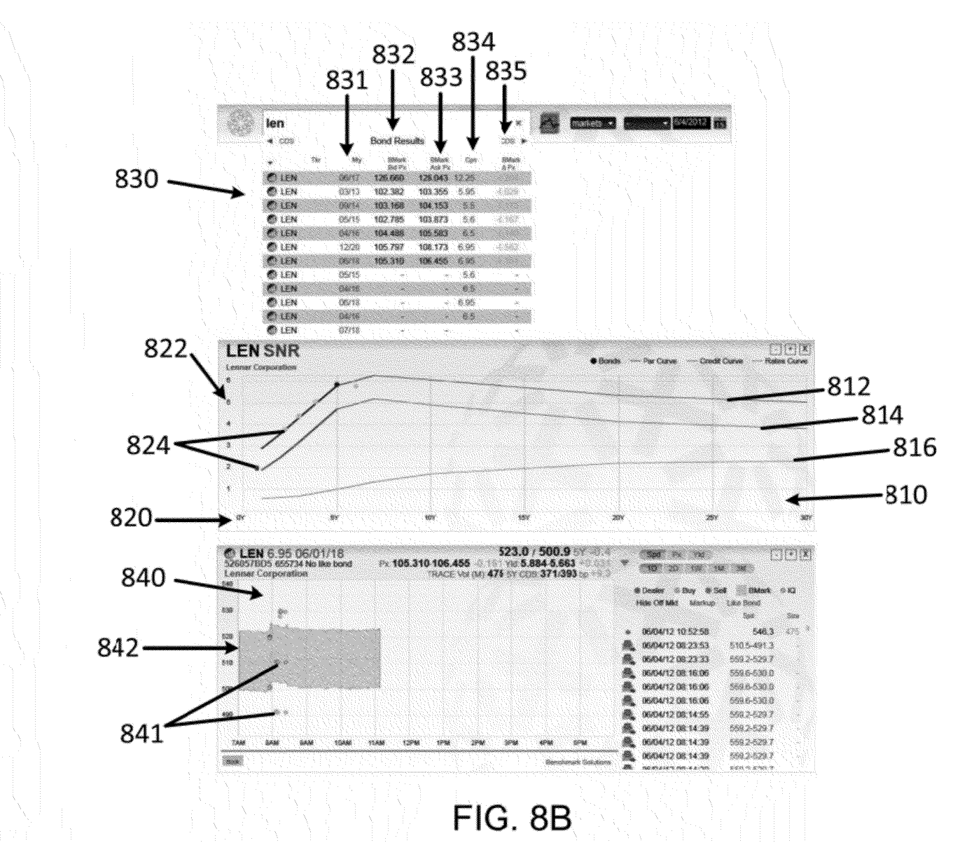

FIG. 8A is an example screen shot that shows a detailed view of the Yield Curve Block 504 of the user interface 500 of FIG. 5. The Yield Curve Block 504 can include an issuer level display of the assorted metrics described above with respect to FIGS. 6 and 7. The Yield Curve Block 4 can include a yield curve chart 801 and a yield curve table 802. The yield curve table 802 presents underlying metrics 803 (e.g., risk-free rates, credit basis, and bond specific basis) across a broad range of maturity terms 804 for the selected bond's issuer, the full rate of the selected bond 805 at each point on the yield curve, and the full rate change measured against a reference time across all terms 806. The yield curve chart 801 includes the metrics 803 presented as a set of curves 807 showing the full term structure of each underlying metric across a broad range of maturity terms for the specified issuer. The user can then view the underlying metrics affecting the price of the requested security propagated across all issues from the specified issuer as they relate to his selection. The values for each of the curves can be calculated by the system based on the market data obtained by the system. For example, the risk-free rates curve 816 corresponds to interest rates calculated by the system across a range of maturity terms based on interest rates observed in the interest rate swap market. The credit basis curve 814 corresponds to the credit basis calculated by the system across a range of maturity terms based on the local credit risk as measured by credit default swaps. The bond basis curve 808 corresponds to the issue-pricing behavior calculated across a range of maturity terms based on factors including, for example, issue size (e.g., number of shares of security at time of issuance), supply, demand, etc. The values calculated by the system can then be summed up and displayed as a full rate curve 809 for the issuer across the range of maturity terms. The plot 807 of the metrics across the full term structure for the issuer can be toggled between a two-dimensional (e.g., with two-dimensional curves) and three-dimensional view (e.g., with three-dimensional curves). The implementation shown in FIG. 8A is a three-dimensional view of the underlying metrics, with a first axis representing the term, and a second axis representing the various interest rates.

FIG. 8B is an example screen shot that shows a Yield Curve Block 810 that includes two-dimensional curves (812, 814, 816). The curves displayed in the Yield Curve Block 810 apply to a particular issuer of a security/financial asset as opposed to a selected issue. The curves are plotted against yield terms (horizontal axis 820) and have a corresponding magnitude measured in interest rate percentage (vertical axis 822). For example, a first curve 812 corresponds to a projected yield curve at par for each financial asset (e.g., fixed income security, derivative or credit default swap) issued by a particular entity (the “Lennar Corporation” in the example shown in FIG. 8B) across different yield terms. The yield curve 812 corresponds to the sum of the credit basis curve 814 and the risk-free rate curve 816. The credit basis curve 814 corresponds to the credit basis calculated by the system across a range of maturity terms based on the local credit risk as measured by credit default swaps. The risk-free rate curve 816 corresponds to interest rates calculated by system across a range of maturity terms based on interest rates observed in the interest rate swap market. Both the credit basis curve 814 and the risk-free rate curve 816 are the underlying metrics of the yield curve at par 812, and, when summed together, equal the yield curve values. Since the Yield Curve Block 810 plots across issues from a particular entity, there is no bond specific basis curve.

The user interface is also capable of displaying where the individual securities of the selected issuer fall within the Yield Curve Block 810. For example, FIG. 8B shows individual securities represented as icons 824 overlying the different curves. It should be noted that the values of the curve are calculated independent of the individual securities 824. The different icons 824 can be displayed with different colors (and/or size, texture, or shape), where each color is representative of a different transaction volume or volume range. For example, the second through fourth points and the sixth point from the left hand side of the Yield Curve Block display 810 can have a first color (e.g., light blue) representing a transaction volume between 1 million and 5 million. In contrast, the first point 824 located at the far left of the display 810 can have a second color (e.g., magenta) representing a transaction volume less than 1 million. And the fifth point 824 from the left hand side of the display can have a third color (e.g., black) representing no transaction volume. Other colors and associated volume ranges may be used as well. For example, each color can represent a different quartile of transaction volume.

Each of the individual securities for a particular issuer can be listed in an Issue List Block 830. The Issue List Block 830 can include information for each security, such as maturity date 831, the current projected bid price 832, the current projected ask price 833, the coupon rate 834, and the change in the projected price 835 relative to some previously specified time.

If a user selects one of the points 824 from the Yield Curve Block 810, a Transaction Data Block display 840 can be launched in which the display 840 includes a graphical representation of valuation data 841 overlaid with market projection information 842, similar to the user interface displays shown in FIGS. 1-3. In contrast to the user interfaces of FIGS. 1-3, the example display 840 shows valuation data in terms of spread, not price.

Though the Yield curve Block 810 of FIG. 8B corresponds to a display of a yield curve and underlying metric curves for a particular issue, the system is not limited in this aspect. In some implementations, the system can be configured to output to a terminal display a user interface that shows a plot of yield curves and/or underlying metric curves for various groupings of financial assets. For example, in some cases, a trader may have one or more portfolios of different bonds or derivatives. The system can be configured to display yield curves and/or underlying metric curves for each of the trader portfolios, such that a trader can view the yield and/or underlying metrics of the financial assets within his/her portfolio across the different maturity terms.

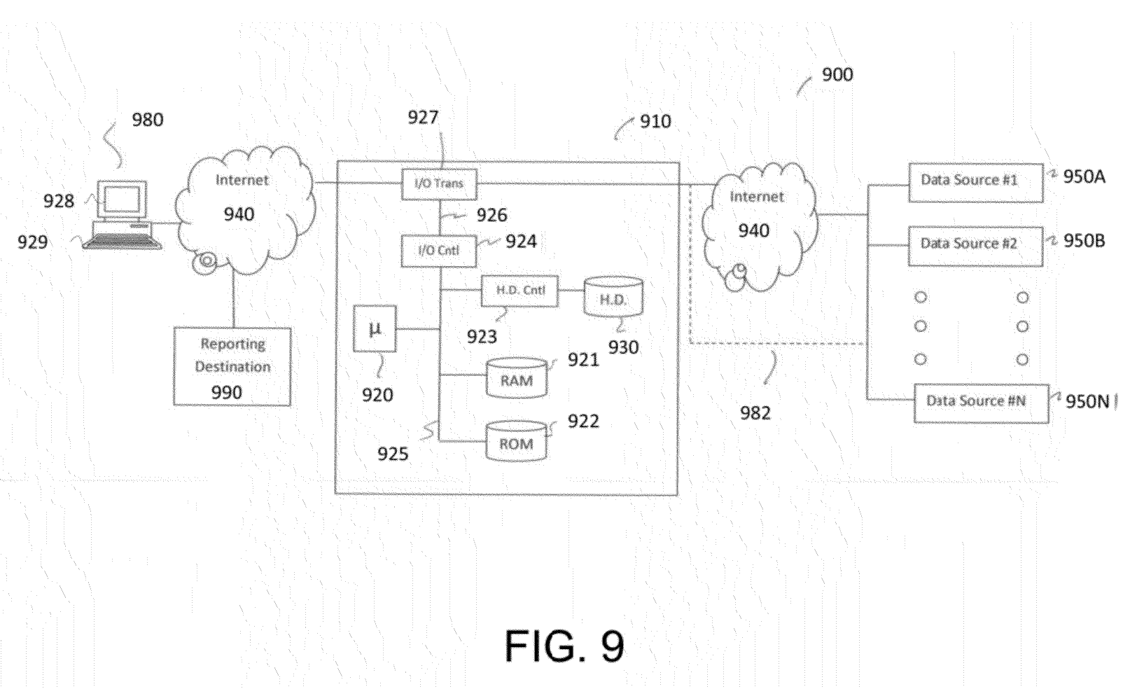

Various implementations of the user interfaces described in this specification can be output to a display device by a data processing apparatus. The financial data presented in the user interfaces can be obtained by the data processing apparatus from one or more data sources coupled to the data processing apparatus, such as computer-readable medium or other data processing apparatus, and/or generated by the data processing apparatus itself. For example, FIG. 9 is a schematic representation of an exemplary system 900 in which the illustrated system 900 includes a data processing apparatus, such as programmable processing system 910. The programmable processing system 910 is coupled via the Internet 940 to a user terminal 980, to a plurality of data sources 950A, 950B . . . 950N and to a reporting destination 990. As indicated by dashed line 982, one or more of the data sources 950A, 950B . . . 950N may be connected directly to the processing system 910.

In a typical implementation, the programmable processing system (system) 910 is operable to output to user terminal 980 and/or to a display device 928 of a user terminal 980, optionally, in conjunction with one or more of the other illustrated components, data corresponding to the user interfaces according to various aspects of the subject matter described in this specification. The system 910 includes a processor 920, a random access memory (RAM) 921, a program memory 922 (for example, a writable read-only memory (ROM) such as a flash ROM), a hard drive controller 923, and an input/output (I/O) controller 924 coupled by a processor (CPU) bus 925. Though not shown, the user terminal 980 also can include a processor, memory and input/output controller. The system 910 can be preprogrammed, in ROM, for example, or it can be programmed (and reprogrammed) by loading a program from another source (for example, from a floppy disk, a CD-ROM, or another computer).

The hard drive controller 923 is coupled to a hard disk 930 suitable for storing executable computer programs, including programs embodying aspects of the subject matter described in this specification, and data discussed in the specification.

The I/O controller 924 is coupled by means of an I/O bus 926 to an I/O interface 927. The I/O interface 927 receives and transmits data (e.g., financial data and/or reporting data related to transactions of one or more securities, financial products and/or assets, including, but not limited to, fixed income securities, bonds, derivatives and credit default swaps) in analog or digital form over communication links such as a serial link, local area network, wireless link, and parallel link. In some implementations, the I/O interface 927 is connected to the display device 928 and a keyboard 929 of the user terminal 980.

In some aspects, the I/O interface 927 is operable as a market data interface for receiving data, such as market financial data associated with one or more different securities (e.g., fixed income assets and over-the-counter (OTC) derivatives). The market financial data can include, for example, transaction data about trades in securities reported by members of FINRA under the TRACE program. Other market financial data can include, for example, transaction data obtained from centralized recordkeeping facilities, such as Swap Data Repositories (SDR) or the municipal securities rulemaking board (MSRB) Real-time Transaction Reporting System (RTRS). Transaction data can include a transaction price or yield associated with one or more transactions of a security, a transaction volume associated with one or more securities, transaction size, identification of the issuer of the security, and/or transaction dates/times, among other information. Market data from other applicable reporting authorities also can be used. Alternatively, or in addition, the market data can include information related to United States Treasury Securities such as, for example, one or more quotes for proposed transactions (e.g., sales or purchases of securities), as well as one or more quotes for transactions of other comparable securities, such as securities issued by the same party or securities issued in the same industry sector. The I/O interface 927 can receive the market data in data feeds over a network. Accordingly, transaction data can include, for example, a subset of the market data previously received.

In a typical implementation, the data can be obtained by one or more sources (e.g., 950A, 950B . . . 950N). The data sources can include, for example, a computer terminal where data is entered manually. In another aspect, the I/O interface 927 is operable as a user query interface for receiving requests from a user terminal to display at least portions of the market data at the user terminal and/or to display information based on the market data (e.g., projected market information such as projected transaction price or projected bid-ask spread of an asset). For example, the I/O interface 927 can receive requests from the user terminal 980 to select a financial product and display market information (e.g., transaction price and/or projected market information) for the selected financial product over a specified period of time. The I/O interface 927 is also operable to output the requested information to the user terminal 980 or other device in response to the request, in which the receiving terminal 980 renders the information to a display device. Example user interface displays of such information are shown in FIGS. 1-8. The I/O interface 927 can provide an access point for a user at user terminal 980 to interact with an access the data and functionality disclosed herein. The I/O interface 927 in the illustrated implementation, also can serve as an interface to a reporting destination 990. Thus, in a typical implementation, any required reporting can be accomplished directly from the user terminal, for example, by accessing the processing system 910.

In some implementations, the user terminal 980 includes one or more user applications, such as a web browser, to facilitate the sending and receiving of data (e.g., transaction data and projected market information) over the network to and from the system 900. By use of these applications, the user terminal 980 can request the data from a website. In turn, the data can be provided to the user terminal 980 by system 900 for presentation by the user terminal 980. A website includes one or more resources (e.g., HTML pages, word processing documents, portable document format (PDF) documents, images, video, and feed sources, to name just a few, with or without embedded information (such as meta information and hyperlinks) and/or embedded instructions (such as JavaScript scripts)) associated with a domain name and hosted by one or more servers. An example website is a collection of web pages formatted in hypertext markup language (HTML) that can contain text, images, multimedia content, and programming elements, such as scripts. The website may provide access to resource that includes a user interface, such as any one of the user interfaces presented in FIGS. 1-8.

The processor 920 may be adapted to calculate (or receive) and store projected market information (e.g., projected transaction price of an asset or projected bid-ask spread of an asset) based on the series of financial market observations. This information, among other information, can be stored in an electronic database, for example, in RAM module 921.

In some aspects, the processor 920 can also be configured to render transaction data and projected market information for a selected asset within a user interface that is output to a display device. The processor 920 can be used to calculate and/or display various metrics (e.g., risk-free rates, credit basis, bond specific basis, current yield spread, first order derivative metrics, second order derivative metrics, security time decay, or overall security price change) based on the transaction data and relationships identified. This information, too, can be stored in an electronic database, for example, in RAM module 921. Alternatively, or in addition, a processor of the user terminal 980 (not shown) can be configured to render the transaction data and projected market information for the selected asset within the user interface. Similarly, the user terminal 980 can be configured to calculate and/or display the various metrics described above and store them in an electronic database that is a part of or coupled to the user terminal 980.

Implementations of the subject matter and the operations described in this specification and the attachments hereto can be implemented in digital electronic circuitry, or in computer software, firmware, or hardware, including the structures disclosed in this specification and their structural equivalents, or in combinations of one or more of them. Implementations of the subject matter described in this specification and the attachments hereto can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The operations described in this specification and attachments hereto can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification and attachments hereto can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification and attachments hereto can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification and attachments hereto can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. For example, in some implementations, the system 900 can correspond to a server whereas the user terminal 980 can correspond to a client. A client and server are generally remote from each other and typically interact through a communication network. The relationship of client and server arises by virtue of computer programs running on the respective computers and having a client-server relationship to each other. In some implementations, a server transmits data (e.g., an HTML page and transaction data) to a client device (e.g., for purposes of displaying data to and receiving user input from a user interacting with the client device). Data generated at the client device (e.g., a result of the user interaction) can be received from the client device at the server.

While this specification and attachments hereto contain many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described herein and the attachments hereto should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures and attachments do not necessarily require the particular order shown, or sequential order, to achieve desirable results. In certain implementations, multitasking and parallel processing may be advantageous.

What is claimed is:

1. A system for generating financial data for display at a user terminal, the system comprising:
a market data interface configured to receive transaction data relating to one or more financial assets, the transaction data comprising the identity of the one or more financial assets, corresponding valuation data for the one or more financial assets, and corresponding volume data for the one or more financial assets;
a user query interface configured to 1) receive requests from a user terminal to display information relating to a first financial asset from the one or more financial assets and 2) send output data to the user terminal;
a processor coupled to the market data interface and the user query interface, the processor being operable to generate the output data for display by the user terminal, wherein the output data, once rendered by the user terminal, comprises a user interface that displays at least a portion of the transaction data relating to the first financial asset and market projection information relating to the first financial asset, wherein the market projection information is substantially contemporaneous with the portion of the transaction data.

2. The system of claim 1, wherein the user interface comprises a display of the transaction data relating to the first financial asset arranged in a scatter plot, and wherein a first-axis of the plot corresponds to valuation data and a second axis of the plot corresponds to time data.

3. The system of claim 2, wherein the transaction data relating to the first financial asset, once rendered by the user terminal, comprises one or more transaction icons, wherein each transaction icon represents a corresponding trade of the first financial asset.

4. The system of claim 3, wherein, for each transaction icon in the display, at least one icon property selected from the group consisting of color, brightness, texture and size is representative of volume data for the corresponding trade of the first financial asset.

5. The system of claim 3, wherein the transaction data relating to the first financial asset further comprises data relating to the identity of a party participating in each trade of the first financial asset.

6. The system of claim 5, wherein, for each transaction icon in the display, at least one icon property selected from the group consisting of color, brightness, texture and size indicates whether the corresponding trade of the first financial asset is a dealer-dealer trade, a buyer-dealer trade, or a seller-dealer trade.

7. The system of claim 3, wherein the user interface comprises a display of the market projection information overlaid with the transaction data.

8. The system of claim 7, wherein the market projection information comprises one or more projected transaction prices for the first financial asset, each transaction icon being substantially contemporaneous with a corresponding projected transaction price.

9. The system of claim 8, wherein the one or more projected transaction prices, once rendered by the user terminal, are in the form of a line plot.

10. The system of claim 8, wherein the market projection information comprises one or more projected bid-ask spread values, each bid-ask spread value being associated with a corresponding projected transaction price.

11. The system of claim 10, wherein the one or more projected bid-ask spread values, once rendered by the user terminal, are in the form of a band surrounding the corresponding one or more projected transaction prices.

12. The system of claim 11, wherein the band is semi-transparent.

13. The system of claim 10, wherein the one or more projected bid-ask spread values, once rendered by the user terminal, are graphically indicative of a difference between a projected bid price for the first financial asset and a projected ask price for the first financial asset.

14. The system of claim 2, wherein the processor is operable to:
receive a request to display the transaction data relating to the first financial asset for a selected time period; and
generate, in response to receiving the request, the output data, wherein the output data comprises the transaction data for the selected time period.

15. The system of claim 1, wherein the user interface comprises a display of a list of selectable financial assets.

16. The system of claim 1, wherein the one or more financial assets comprises a fixed income security or a derivative.

17. The system of claim 1, wherein the market data interface is further configured to receive underlying data associated with the valuation data of the first financial asset, the underlying data comprising at least one metric selected from the group consisting of current risk-free rates, local credit basis, and fixed income security specific basis.

18. The system of claim 17, wherein the processor is operable to generate additional output data for display by the user terminal, and wherein the additional output data, once rendered by the user terminal, comprises a comparison of the underlying data associated with the first financial asset on a first date to the underlying data associated with the first financial asset on a second date.

19. The system of claim 18, wherein the user interface comprises a display of the effect of the underlying data on the valuation of the first financial asset.

20. The system of claim 17, wherein the user interface comprises a display of a yield curve for the first financial asset based at least in part on the underlying data for the first financial asset over different maturity terms, wherein the yield curve is arranged in a two-dimensional or three-dimensional plot.

21. The system of claim 20, wherein the user interface comprises a display of the yield curve plotted against the different maturity terms.

22. The system of claim 17, wherein the user interface comprises a display of an issuer yield curve, wherein the issuer yield curve represents a yield value for each financial asset issued by the issuer.

23. A machine-implemented method comprising:
obtaining, using a data processing apparatus, transaction data relating to one or more financial assets, the transaction data comprising the identity of the one or more financial assets, corresponding valuation data for the one or more financial assets, and corresponding volume data for the one or more financial assets;
receiving, at the data processing apparatus, a request to display information relating to a first financial asset from the one or more financial assets;
generating, using the data processing apparatus and in response to receiving the request, output data for display at a user terminal, wherein the output data, once rendered by the user terminal, comprises a user interface that displays at least a portion of the transaction data relating to the first financial asset and market projection information relating to the first financial asset, wherein the market projection information is substantially contemporaneous with the portion of transaction data; and
transmitting the output data to the user terminal.

24. The machine-implemented method of claim 23, wherein the user interface comprises a display of the transaction data relating to the first financial asset arranged in a scatter plot, and wherein a first-axis of the plot corresponds to valuation data and a second axis of the plot corresponds to time data.

25. The machine-implemented method of claim 24, wherein the transaction data relating to the first financial asset, once rendered by the user terminal, comprises one or more transaction icons, wherein each transaction icon represents a corresponding trade of the first financial asset.

26. The machine-implemented method of claim 25, wherein, for each transaction icon in the display, at least one icon property selected from the group consisting of color, brightness, texture and size is representative of volume data for the corresponding trade of the first financial asset.

27. The machine-implemented method of claim 25, wherein the transaction data relating to the first financial asset further comprises data relating to the identity of a party participating in each trade of the first financial asset.

28. The machine-implemented method of claim 27, wherein, for each transaction icon in the display, at least one icon property selected from the group consisting of color, brightness, texture and size indicates whether the corresponding trade of the first financial asset is a dealer-dealer trade, a buyer-dealer trade, or a seller-dealer trade.

29. The machine-implemented method of claim 25, wherein the user interface comprises a display of the market projection information overlaid with the transaction data.

30. The machine-implemented method of claim 29, wherein the market projection information comprises one or more projected transaction prices for the first financial asset, each transaction icon being substantially contemporaneous with a corresponding projected transaction price.

31. The machine-implemented method of claim 30, wherein the one or more projected transaction prices, once rendered by the user terminal, are in the form of a line plot.

32. The machine-implemented method of claim 30, wherein the market projection information comprises one or more projected bid-ask spread values, each bid-ask spread value being associated with a corresponding projected transaction price.

33. The machine-implemented method of claim 32, wherein the one or more projected bid-ask spread values, once rendered by the user terminal, are in the form of a band surrounding the corresponding one or more projected transaction prices.

34. The machine-implemented method of claim 33, wherein the band is semi-transparent.

35. The machine-implemented method of claim 32, wherein the one or more projected bid-ask spread values, once rendered by the user terminal, are graphically indicative of a difference between a projected bid price for the first financial asset and a projected ask price for the first financial asset.

36. The machine-implemented method of claim 24, further comprising:
receiving, at the data processing apparatus, a request to display the transaction data relating to the first financial asset for a selected time period; and
generating, in response to receiving the request, the output data, wherein the output data comprises the transaction data for the selected time period.

37. The machine-implemented method of claim 23, wherein the user interface comprises a display of a list of selectable financial assets.

38. The machine-implemented method of claim 23, wherein the one or more financial assets comprises a fixed income security or a derivative.

39. The machine-implemented method of claim 23, further comprising obtaining, using the data processing apparatus, underlying data associated with the valuation data of the first financial asset, the underlying data comprising at least one of current risk-free rates, local credit basis, and fixed income security specific basis.

40. The machine-implemented method of claim 39, further comprising generating, using the data processing apparatus, additional output data for display by the user terminal, wherein the additional output data, once rendered by the user terminal, comprises a comparison of the underlying data associated with the first financial asset on a first date to the underlying data associated with the first financial asset on a second date.

41. The machine-implemented method of claim 40, wherein the user interface comprises a display of the effect of the underlying data on the valuation of the first financial asset.

42. The machine-implemented method of claim 39, wherein the user interface comprises a display of a yield curve for the first financial asset based at least in part on the underlying data for the first financial asset over different maturity terms, wherein the yield curve is arranged in a two-dimensional or three-dimensional plot.

43. The machine-implemented of claim 42, wherein the user interface comprises a display of the yield curve plotted against the different maturity terms.

44. The machine-implemented of claim 39, wherein the user interface comprises a display of an issuer yield curve, wherein the issuer yield curve represents a yield value for each financial asset issued by the issuer.

45. A machine-implemented method comprising:
sending, to a first computing device, over a communication network, a request to display information relating to a first financial asset;
receiving, from the first computing device, output data, wherein the output data comprises transaction data relating to the first financial asset and market projection information relating to the first financial asset, wherein the market projection information is substantially contemporaneous with the transaction data; and
rendering the output data at a user terminal to form a user interface, wherein the user interface comprises a display of the transaction data relating to the first financial asset and the market projection information relating to the first financial asset.

46. The machine-implemented method of claim 45, wherein the transaction data is arranged in a scatter plot in the user interface, and wherein a first-axis of the plot corresponds to valuation data and a second axis of the plot corresponds to time data.

47. The machine-implemented method of claim 46, wherein the transaction data comprises one or more transaction icons, wherein each transaction icon represents a corresponding trade of the first financial asset.

48. The machine-implemented method of claim 47, wherein the market projection information is overlaid with the transaction data.

49. The machine-implemented method of claim 48, wherein the market projection information comprises one or more projected transaction prices for the first financial asset, each transaction icon being substantially contemporaneous with a corresponding projected transaction price.

50. The machine-implemented method of claim 49, wherein the market projection information comprises one or more projected bid-ask spread values, each bid-ask spread value being associated with a corresponding projected transaction price.

51. A system for generating financial data for display at a user terminal, the system comprising:
a market data interface configured to receive financial data relating to a plurality of financial assets;
a user query interface configured to 1) receive requests from a user terminal to display market factors relating to a subset of the plurality of financial assets and 2) send output data to the user terminal;
a processor coupled to the market data interface and the user query interface, the processor being operable to generate, for display by the user terminal, the output data based on the financial data received at the market data interface, wherein the output data, once rendered by the user terminal, comprises a user interface that displays a plot of a yield curve over a range of maturity terms.

52. The system of claim 51, wherein the market factors comprise interest rates associated with the plurality of financial assets and local credit risk associated with the plurality of financial assets.

53. The system of claim 52, wherein the output data, once rendered by the user terminal, comprises a user interface that displays one or more of a plot of a risk-free rate curve over the range of maturity terms, a plot of a credit basis curve over the range of maturity terms, and a plot of a bond basis curve over the range of maturity terms.

54. The system of claim 51, wherein the yield curve is associated with a portfolio of financial assets issued by a single entity.

55. The system of claim 51, wherein the yield curve is associated with a portfolio of financial assets issued by multiple different entities.

56. A machine-implemented method comprising:
obtaining, using a data processing apparatus, financial data relating to a plurality of financial assets;
receiving, at the data processing apparatus, a request to display factors relating to a subset of the plurality of financial assets;
generating, using the data processing apparatus and in response to receiving the request, output data for display at a user terminal, wherein the output data, once rendered by the user terminal, comprises a user interface that displays a plot of a yield curve over a range of maturity terms; and
transmitting the output data to the user terminal.

57. The machine-implemented method of claim 56, wherein the market factors comprise interest rates associated with the plurality of financial assets and local credit risk associated with the plurality of financial assets.

58. The machine-implemented method of claim 56, wherein the output data, once rendered by the user terminal, comprises a user interface that displays one or more of a plot of a risk-free rate curve over the range of maturity terms, a plot of a credit basis curve over the range of maturity terms, and a plot of a bond basis curve over the range of maturity terms.

59. The machine-implemented method of claim 56, wherein the yield curve is associated with a portfolio of financial assets issued by a single entity.

60. The machine-implemented method of claim 56, wherein the yield curve is associated with a portfolio of financial assets issued by multiple different entities.

61. A machine-implemented method comprising:
sending, to a first computing device, over a communication network, a request to display factors relating to a plurality of financial assets;
receiving, from the first computing device, output data; and
rendering the output data at a user terminal to form a user interface, wherein the user interface displays a plot of a yield curve over a range of maturity terms, the yield curve being associated with a portfolio of financial assets issued by multiple different entities or a portfolio of financial assets issued by a single entity.

62. The machine-implemented method of claim 61, wherein the user interface displays one or more of a plot of a risk-free rate curve over the range of maturity terms, a plot of a credit basis curve over the range of maturity terms, and a plot of a bond basis curve over the range of maturity terms.
